(19) United States
(12) Patent Application Publication
(10) Pub. No.: US 2023/0297307 A1
(43) Pub. Date: Sep. 21, 2023

(54) DIGITAL SIGNAGE DEVICE

(71) Applicant: TOSHIBA TEC KABUSHIKI KAISHA, Tokyo (JP)

(72) Inventors: Naoki SEKINE, Mishima Shizuoka (JP); Shogo WATADA, Numazu Shizuoka (JP)

(21) Appl. No.: 17/982,440

(22) Filed: Nov. 7, 2022

(30) Foreign Application Priority Data
Mar. 18, 2022 (JP) 2022-044288

(51) Int. Cl. G06F 3/14; G10L 15/26; G10L 15/18

(52) U.S. Cl. CPC G06F 3/14; G10L 15/1815; G10L 15/26; G06F 3/041

(57) ABSTRACT

A digital signage device for outputting a guidance message in response to an inquiry from a user, includes a display including a touch panel and configured to display a guidance screen, an input device through which the user can make speech inputs, an output device through which a guidance message is output, and a processor configured to, when the guidance screen is operated and the speech is input, convert speech data generated by the input device from the speech input into text data, search the text data for one or more particular words and determine a politeness level based on the particular words found in the text data, determine a plurality of response messages based on the text data, select one of the response messages corresponding to the determined politeness level, and control the output device to output the selected response message as a guidance message.

### CROSS-REFERENCE TO RELATED APPLICATION(S)

This application is based upon and claims the benefit of priority from Japanese Patent Application No. 2022-044288, filed Mar. 18, 2022, the entire contents of which are incorporated herein by reference.

### FIELD

Embodiments described herein relate generally to a digital signage device for outputting a guidance message, a method for outputting a guidance message, and a non-transitory computer readable medium storing a program for outputting a guidance message.

### BACKGROUND

An information processing apparatus that recognizes a user’s speech (e.g., inquiry) that has been input via a microphone and automatically responds is already known. Such an information processing apparatus is generally configured to convert speech data into text data, analyze the text data to determine the user’s intention, and choose and return one of preset responses corresponding to the user’s intention. The responses are categorized into a groups corresponding to the user’s intention. For this reason,, the same response is returned if the inquiry is determined to be made with the same intention, which may sound like a mechanical response. In view of such circumstances, it has been desired to be able to provide a flexible response to a user’s inquiry.

### SUMMARY OF THE INVENTION

Embodiments of this disclosure provide an information processing apparatus and an information processing program capable of flexibly responding to a user.

In one embodiment, a digital signage device for outputting a guidance message in response to an inquiry from a user, includes a display including a touch panel and configured to display a guidance screen, an input device through which the user can make speech inputs, an output device through which a guidance message is output, and a processor. The processor is configured to, when the guidance screen is operated and the speech is input, convert speech data generated by the input device from the speech input into text data, search the text data for one or more particular words and determine a politeness level based on the particular words found in the text data, determine a plurality of response messages based on the text data, select one of the response messages corresponding to the determined politeness level, and control the output device to output the selected response message as a guidance message.

### BRIEF DESCRIPTION OF THE DRAWINGS

FIG. 1 is a circuit block diagram of a digital signage device according to an embodiment.

FIG. 2 is a view illustrating an external appearance of the digital signage device illustrated in FIG. 1.

FIG. 3 is a diagram schematically illustrating a data record included in a score table stored in the digital signage device.

FIG. 4 is a diagram schematically illustrating a data record included in an action table stored in the digital signage device.

FIG. 5 is a diagram schematically illustrating a data record included in a response table stored in the digital signage device.

FIG. 6 is a flowchart of information processing performed by the digital signage device.

FIG. 7 is a flowchart of a politeness level calculation process performed by the digital signage device.

### DETAILED DESCRIPTION

Hereinafter, exemplary embodiments will be described with reference to the drawings. In this disclosure, a digital signage device 1 is described as an example of an information processing apparatus.

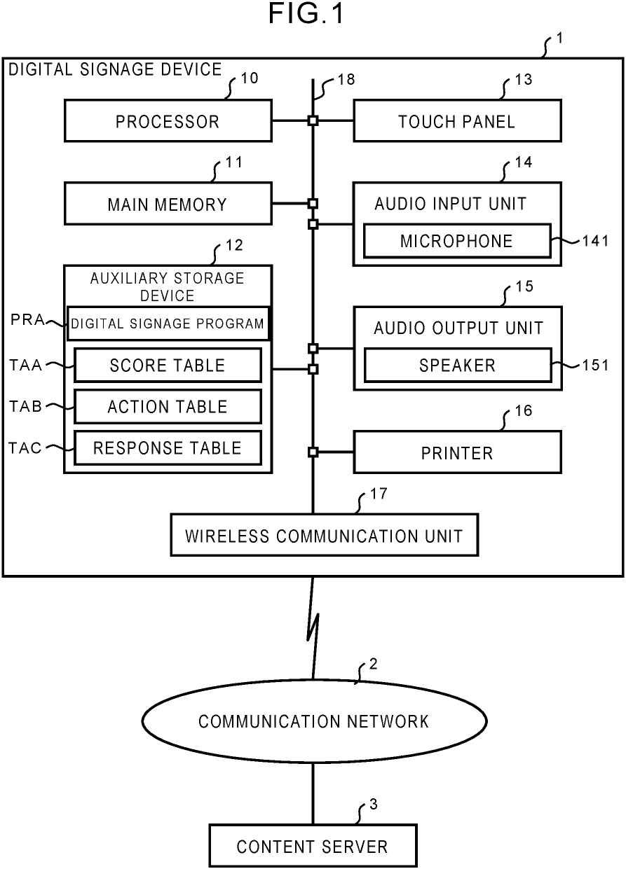

FIG. 1 is a circuit block of the digital signage device 1 according to an embodiment. The digital signage device 1 is installed in a place where an unspecified number of people may be present, such as a store or a shopping mall, and displays a content screen representing advertisement information or the like.

The digital signage device 1 includes a processor 10, a main memory 11, an auxiliary storage device 12, a touch panel 13, an audio input unit 14, an audio output unit 15, a printer 16, a wireless communication unit 17, and a transmission path 18. The processor 10, the main memory 11, the auxiliary storage device 12, the touch panel 13, the audio input unit 14, the audio output unit 15, the printer 16, and the wireless communication unit 17 can communicate with each other via the transmission path 18. The processor 10, the main memory 11, and the auxiliary storage device 12 are connected to each other via the transmission path 18, thereby forming a controller for controlling the digital signage device 1.

The processor 10 performs various functions as the digital signage device 1 by executing one or more information processing programs such as an operating system (OS) and an application program.

The main memory 11 includes a read-only memory area and a rewritable memory area. In the main memory 11, one or more of the information processing programs are stored in the read-only memory area. Data necessary for the processor 10 to execute processing for controlling each unit may be stored in the read-only memory area or the rewritable memory area. The rewritable memory area is used as a work area by the processor 10.

The auxiliary storage device 12 is, for example, a EEPROM (electric erasable programmable read-only memory), HDD (hard disc drive), SSD (solid state drive), or any other known storage device. The auxiliary storage device 12 stores data used by the processor 10 to perform various types of processing and data generated by the processor 10. The auxiliary storage device 12 may store the above-described information processing programs. In the present embodiment, the auxiliary storage device 12 stores a digital signage program PRA which is one of the information processing programs. The digital signage program PRA is an application program for an information processing sequence to be described later for performing the functions of the digital signage device 1. A part of the storage area of the auxiliary storage device 12 is used to store a score table TAA, an action table TAB, and a response table TAC. Each table will be described later.

The touch panel 13 includes a display device for displaying a screen and an input device for inputting a touch operation on the screen.

The audio input unit 14 is an input device used for a user facing the digital signage device 1 to input his or her speech. The audio input unit 14 includes, for example, a microphone 141 by which a speech can be input by the user. Then, the audio input unit 14 digitizes the audio signal obtained by the microphone 141 to obtain audio data.

The audio output unit 15 is an output device that outputs a sound corresponding to audio data under the control of the processor 10. The audio output unit 15 includes a speaker 151 arranged to output audio to the periphery of the digital signage device 1. The audio output unit 15 converts the audio data sent under the control of the processor 10 into a required audio signal and supplies the audio signal to the speaker 151.

The printer 16 prints any image on a print medium, such as paper, under the control of the processor 10.

The wireless communication unit 17 wirelessly accesses a communication network 2 and performs processing for communication with an external content server 3 and the like via the communication network 2. As the wireless communication unit 17, for example, a conventional wireless LAN (local area network) device can be used. In place of the wireless communication unit 17 or in addition to the wireless communication unit 17, a communication device of a type that accesses the communication network 2 by wire (e.g., a network interface circuit) may be provided.

The transmission path 18 includes an address bus, a data bus, a control signal line, and the like, and transmits data and control signals transmitted and received between the connected units.

As the communication network 2, the Internet, a VPN (virtual private network), a LAN, a public communication network, a mobile communication network, and the like can be used singly or in combination as appropriate.

The content server 3 manages content data representing various content screens to be displayed by the digital signage device 1, and provides the content data to the digital signage device 1 as necessary.

The digital signage device 1 is provided after the digital signage program PRA is stored in the auxiliary storage device 12. However, hardware in a state in which the digital signage program PRA is not stored in the auxiliary storage device 12, or in a state in which the same type of application program is stored in the auxiliary storage device 12, may be provided separately from the digital signage program PRA. Then, the digital signage device 1 may be configured by writing the digital signage program PRA in the auxiliary storage device 12 in accordance with an operation of any worker. The digital signage program PRA can be installed from a removable, non-transitory computer readable storage medium such as a magnetic disk, a magneto-optical disk, an optical disk, a semiconductor memory, or the like, or by communication via a network.

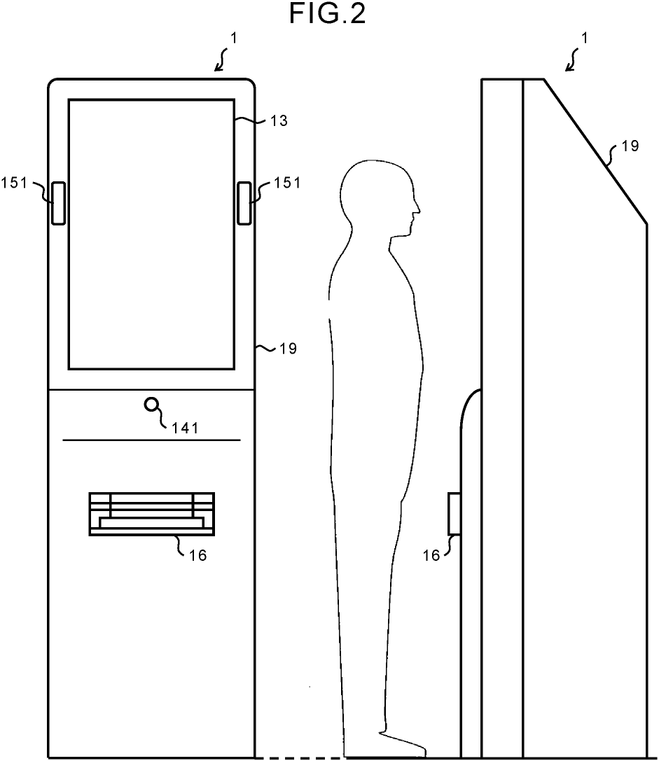

FIG. 2 is a view illustrating an external appearance of the digital signage device 1. The left side of FIG. 2 shows a front view of the digital signage device 1, and the right side shows a side view of the digital signage device 1 in a state in which a user faces the digital signage device 1.

As shown in FIG. 2, the digital signage device 1 further includes a housing 19. The housing 19 has a longitudinally elongated shape and houses and supports the elements shown in FIG. 1. The housing 19 supports the touch panel 13 at the front side of the housing 19. The housing 19 supports the microphone 141 on its front surface so as to be able to receive the speech of the user facing the microphone 141 as shown. The housing 19 supports the speaker 151 on its front surface so as to output sound in a manner that can be heard by the user facing the speaker 151 as shown. The housing 19 supports the printer 16 so that a print medium on which an image is printed can be discharged to the outside of the housing 19.

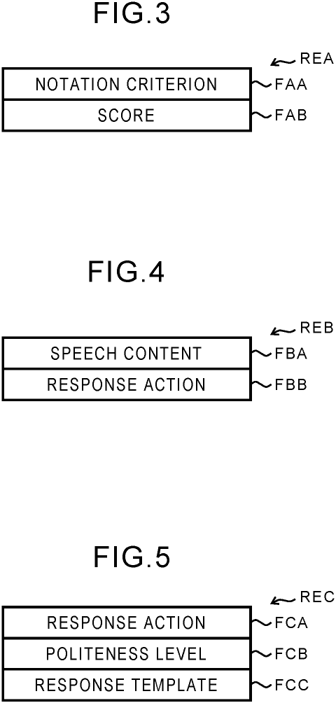

FIG. 3 is a diagram schematically illustrating a data record REA included in the score table TAA.

The score table TAA stores a plurality of data records REA. Each data record REA includes fields FAA and FAB. In the fields FAA of the data records REA, different notation criteria are set. The field FAB of each data record REA stores a numerical value representing a score for a word that meets the notation criterion set in the field FAA of the same data record REA. In the data record REA, for example, information representing polite languages, such as “Please” “Could” and “Would,” is set in the field FAA as a notation criterion, and “3” defined as a score for a word that meets the notation criterion is set in the field FAB. Further, in the data record REA, for example, information representing words that indicate desire, verbs, and particles is set in the field FAA as a notation criterion, and “1” defined as a score for a word matching the notation criterion is set in the field FAB.

FIG. 4 is a diagram schematically illustrating a data record REB included in the action table TAB.

The action table TAB stores a plurality of data records REB. Each data record REB includes fields FBA and FBB. In the field FBA of each data record REB, a speech content is set differently. In the field RBB of each data record REB, a response action to be performed corresponding to the speech content set in the field FBA of the same data record REB is set. In the data record REB, for example, information representing a sentence for determining the content of a response, such as “the location of a nearby restroom”, “the location of a particular merchandise item”, “the stock quantity of a particular merchandise item”, and “gift wrapping service”, are set in the fields FBA as speech contents, and corresponding response actions such as “tell the location of a nearby restroom”, “tell the location of a shelf displaying the particular merchandise item”, “answer the stock quantity of the particular merchandise item”, and “call a store clerk” are set in the corresponding fields FBB.

FIG. 5 is a diagram schematically illustrating a data record REC included in the response table TAC.

The response table TAC stores a plurality of data records REC. Each data record REC includes fields FCA, FCB, and FCC. In the field FCA of each data record REC, a response action is set. In some of the data records REC, the same response action may be set in the field FCA. In the field FCB of each data record REC, a numerical value indicating a politeness level is set. The field FCB of each data record REC having the same responding action set in the field FCA stores a different numerical value as the politeness level. The field FCC associated with the response action in the field FCB and the politeness level in the field FCC stores a response template.

As an example, each field FCA of three data records REC stores the same response action “tell the location of a nearby restroom”, the corresponding fields FCB store “3”, “2”, and “1”, and the corresponding fields FCC store, as the response templates: “Thank you for your inquiry. Please turn right 50 meters ahead. You can see it on your left.” “Please turn right 50 meters ahead.” “Turn right 50 meters ahead.” As another example, in the fields FCC of three data records REC in which the same response action “call a store clerk” is set in the field FCA and “3”, “2”, and “1” are set in the corresponding fields FCB, “I will call a store clerk. Please wait.”, “Please wait for a while.” “Please wait after calling.” are set.

The content of the score table TAA, the action table TAB, and the response table TAC may be appropriately determined by, for example, a designer of the digital signage device 1, a manufacturing worker of the digital signage device 1, an installation worker for installing the digital signage device 1 at the use location, or an administrator of the digital signage device 1. The range and the number of numerical values used as the score and the range and the number of numerical values used as the politeness level can be freely set. In one embodiment, all of the numerical values used as scores and politeness levels are three of “3”, “2”, and “1”.

Next, the operation of the digital signage device 1 configured as described above will be described.

When the digital signage device 1 is in the normal operating condition, the processor 10 performs information processing by executing the digital signage program PRA.

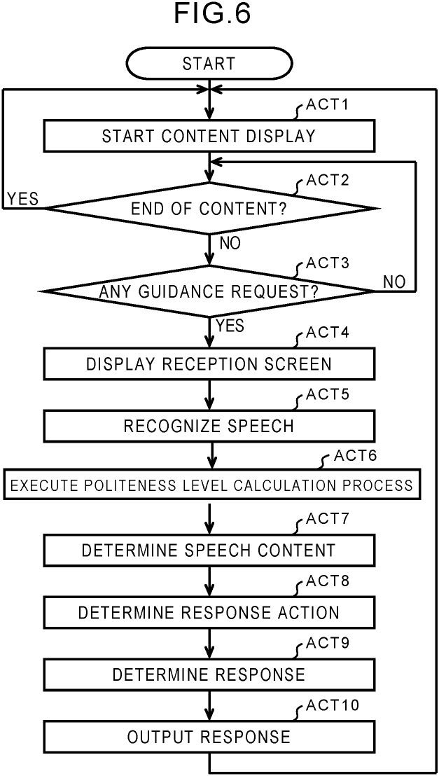

FIG. 6 is a flowchart of information processing performed by the processor 10. Note that the contents of the processing described below are examples, and the order of the steps may be changed, one or more of the steps may be omitted, and one or more other steps may be added as appropriate.

In ACT1, the processor 10 controls the touch panel 13 to display a content screen. For example, the processor 10 selects one of the content data provided by the content server 3 in accordance with a predetermined rule, and starts displaying the content screen representing advertisement information or the like on the touch panel 13 based on the content data. The processor 10 may cause the content screen to be displayed on the basis of the content data downloaded from the content server 3 in real time, or may cause the content screen to be displayed on the basis of the content data by being downloaded in advance and stored in the auxiliary storage device 12.

In ACT2, the processor 10 checks whether the display of the content screen has ended (e.g., the advertisement information such as a commercial video has been displayed) . If not, the processor 10 proceeds to ACT3. In ACT3, the processor 10 checks whether any guidance, e.g., a guidance about the location of a nearby restroom, is requested. If not, the processor 10 returns to ACT2. Thus, the processor 10 waits in ACT2 and ACT3 for the displayed content to end or for any guidance to be requested.

In ACT2, when the display of the content screen has ended, the processor 10 returns to ACT1 to re-select the content and begin displaying the content. Thus, the processor 10 maintains a state in which the content screen is displayed on the touch panel 13 as long as no guidance is requested. Thus, the digital signage device 1 performs the same operation as that of the existing digital signage device.

If a user wants to use the guidance function of the digital signage device 1, the user requests guidance by a predetermined operation such as touching a button represented on the content screen, for example, while facing the digital signage device 1 as shown in FIG. 2. In response to such operation being detected by the touch panel 13 or the like, the processor 10 determines YES in ACT3 and proceeds to ACT4.

In ACT4, the processor 10 controls the touch panel 13 to display a reception screen. The reception screen is a screen for prompting the user to speak what kind of guidance is desired.

The user speaks to the microphone 141 what guidance he or she wants. The user may speak any sentence. For example, when the user wants to receive guidance about a nearby toilet, he/she may speak with various emotional content such as “Would you tell me where the restroom is?”, “I want to pee”, “restroom” and “where is the restroom”.

When the user speaks, the audio input unit 14 converts the speech that has been input by the microphone 141 into a signal and further digitizes the signal to obtain speech data.

In ACT5, the processor 10 performs speech recognition on the speech data obtained by the audio input unit 14 as described above with respect to the speech of the user. The processing performed by the processor 10 for speech recognition may be, for example, a well-known processing. As a result of the speech recognition, the processor 10 obtains text data representing a sentence corresponding the speech data. Thus, when the processor 10 executes the information processing based on the digital signage program PRA, the processor 10 recognizes the speech content from the speech data. The processor 10 may execute information processing for recognizing characters as information processing based on an information processing program different from the digital signage program PRA.

In ACT6, the processor 10 starts a politeness level calculation process. The processor 10 executes the politeness level calculation process in parallel with the information processing illustrated in FIG. 6, for example, as processing of a thread different from the information processing illustrated in FIG. 6. However, the processor 10 may execute the politeness level calculation process in the information processing illustrated in FIG. 6. That is, the processor 10 may, for example, finish the politeness level calculation process In ACT6 and then proceed to ACT7 to be described later.

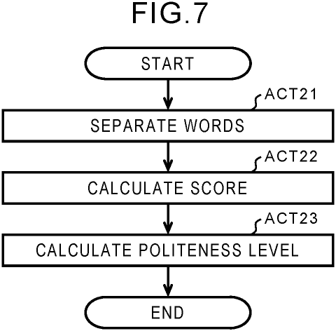

FIG. 7 is a flowchart of the politeness level calculation process.

In ACT21, the processor 10 separates the words included in the sentences represented by the text data obtained by ACT5. The processor 10 separates words, for example, using well-known morphological analysis techniques. As an example, the processor 10 separates the sentence “where is the restroom” into the words “where” “is”, “the”, and “restroom”. Further, as another example, the processor 10 separates the sentence “I want to pee” into the words “I”, “want”, “to”, and “pee”.

In ACT22, the processor 10 calculates a score regarding the politeness level of the sentence represented by the text data obtained by ACT5. The processor 10 determines, for example, a score for each of the words separated by ACT21 with reference to the score table TAA. More specifically, the processor 10 finds the data record REA having the notation criterion that meets the word in the field FAA and determines the score set in the corresponding field FAB as the score for the word. Then, the processor 10 calculates the sum of the scores of the words separated by ACT21 as the scores related to the politeness level of the sentence represented by the text data obtained by ACT5.

In ACT23, the processor 10 calculates the politeness level of the sentence represented by the text data obtained by ACT5. For example, the processor 10 sets the score obtained by averaging or normalizing the scores calculated by ACT 22 as the politeness level.

As an example, when the score of each word of “where”, “is”, “the”, and “restroom” is determined to be “3”, “3”, “1”, and “1”, the processor 10 calculates “8” as the score of the sentence of “where is the restroom.” Then, the processor 10 rounds the calculation result by the calculation of [8 points/4 words] by a predetermined method, and calculates, for example, “2” as the politeness level. Then, the processor 10 stores the calculated politeness level in the main memory 11 or the auxiliary storage device 12, and then ends the politeness level calculation process.

The politeness of the speech varies according to the user’s psychological state. For this reason, the politeness level is one of the index values related to the user’s psychological state. Thus, the processor 10 executes the digital signage program PRA to determine such index values.

The processor 10 proceeds from ACT6 to ACT7 in the information processing illustrated in FIG. 6 after executing the politeness level calculation process as described above.

In ACT7, the processor 10 determines the content of the user’s speech based on the sentence represented by the text data obtained by ACT5 and the type of guidance requested by the user. For example, the processor 10 can determine that the content of the user’s speech is a request for guidance about the location of a nearby restroom from various expressions related to a restroom, e.g., “where is the restroom”, “I want to pee”, “where is the restroom”, and the like in a case where a guidance is requested in ACT3. The processing performed by the processor 10 to determine the speech content may be, for example, a well-known processing, e.g., machine learning.

In ACT8, the processor 10 determines a response action according to the content of the speech of the user. For example, the processor 10 searches for a data record REB in which the speech content obtained as a result of ACT7 is set in the field FBA from the action table TAB, and determines a response action set in the field FBB of the corresponding data record REB as the response action according to the speech content of the user. The processor 10 determines, as an example, a response action of “tell the location of a nearby restroom” corresponding to the speech content “the location of a nearby restroom”.

In ACT9, the processor 10 determines a response to the user. For example, the processor 10 determines, as a response to the user, the response template set in the field FCC of the data record REC in which the response action determined by ACT8 is set in the field FCA and the politeness level calculated by the politeness level calculation process is set in the field FCB.

As an example, the processor 10 determines, when a response action is “tell the location of a nearby restroom” and the calculated politeness level is “3”, the response template “Thank you for your inquiry. Please turn right 50 meters ahead. You can see it on your left” as a response. As another example, the processor 10 determines, when a response action as “tell the location of a nearby restroom” and the calculated politeness level is “2”, the response template “Please turn right 50 meters ahead” as a response. As yet another example, the processor 10 determines, when a response action is “tell the location of a nearby restroom” and the calculated politeness level is “1”, the response template of “Turn right 50 meters ahead” as a response.

In ACT10, the processor 10 outputs the response determined by ACT9 according to the response template. For example, the processor 10 generates audio data corresponding to the response determined by ACT9, and supplies the audio data to the audio output unit 15. Then, the audio output unit 15 supplies the audio signal converted from the audio data to the speaker 151, and outputs the audio corresponding to the audio signal from the speaker 151. Thus, as an example, one of “Thank you for your inquiry. Please turn right 50 meters ahead. You can see it on your left.”, “Please turn right 50 meters ahead.” or “Turn right 50 meters ahead.” is output as a sound. Thus, the processor 10 executes the digital signage program PRA to output a response as a sound with the audio output unit 15.

The processor 10 returns to ACT1 when it finishes outputting the response. The processor 10 may return to ACT1 after the sound corresponding to the response is output only once, or after the sound corresponding to the response is repeatedly output a predetermined number of times or during a predetermined period, or after the stop operation is input by the user. In addition, the processor 10 may return to ACT4 when the response has been output, and return to ACT1 in response to a predetermined operation or the like that instructs the termination of the guidance.

Thus, although the digital signage device 1 normally displays a content screen for advertisement or the like, various kinds of guidance can be given to the user in response to a request from the user. Then, when the digital signage device 1 guides the location of a nearby restroom, for example, in response to an inquiry regarding the location of the restroom, the digital signage device 1outputs a voice sound with politeness that matches the politeness level of the user’s inquiry, such as “Thank you for your inquiry. Please turn right 50 meters ahead. You can see it on your left.”, “Please turn right 50 meters ahead.” or “Turn right 50 meters ahead.” Thus, the digital signage device 1 can give a flexible response according to the user.

Various modifications can be made to the above-described embodiments as follows.

The functions described above may be performed by a device different from the digital signage device 1. For example, those functions are performed by various devices operated by a user such as a self-service POS (point-of-sale) terminal, a vending machine, or an automatic ticket vending machine.

The functions described above can also be performed by a dedicated apparatus that responds to the intention of an inquiry determined from text data. As an example, the display function of the content screen in the digital signage device 1 according to the above-described embodiments can be omitted, and the display function can be performed by an apparatus that provides guidance to the users. Further, the above-described functions can be performed by a web server that provides information for guidance as a web service via an information communication terminal as a user interface. Alternatively, the above-described functions can be performed by an information processing device such as a smartphone according to one or more application programs.

The digital signage device 1 may acquire text data output from another device. In this case, the text data may be obtained by speech recognition in the other apparatus, or may be input from an input device such as a keyboard.

The index value related to the psychological state may be another arbitrary index value such as a value obtained by quantifying, for example, joy, anger, sorrow, and pleasure, as long as the index value represents a difference occurring according to the psychological state among different sentences representing the same intention.

The politeness level may be determined in accordance with a predetermined rule, and the rule may be appropriately determined by the developer of the digital signage program PRA or the like. For example, a certain politeness level can be used when text data satisfies a condition associated with the politeness level. As an example, [Politeness level 3 if the sentence starts from “Would”], [Politeness level 2 if the sentence starts from “Please”], [Politeness level 1 if the sentence starts from a verb], etc. For example, if a user says, “Please tell me the location of the restroom”, it is judged as Politeness level 2.

The politeness level may be determined by class classification. As an example, politeness levels are set to a plurality of example sentences prepared in advance, and a class classifier is created by a supervised machine learning method. Then, the class classifier outputs the class to which a user’s speech content belongs, that is, the politeness level. More specifically, Good/Bad flag may be changed to, for example, three levels of politeness using a known technique.

The politeness level may be determined by dividing thresholds by regression. For example, for a large number of example sentences prepared in advance, sequential politeness levels 1-10 are given, and a regression model is created by a supervised machine learning method. Then, with respect to a sentence representing a speech content, a value output from the above-described regression model is subjected to threshold processing by a predetermined threshold value, and the politeness level is determined.

The response may be output by another method in addition to or instead of audio output. As an output by another method, visual output on a display device such as the touch panel 13, printing by a printing device such as the printer 16, or sending of response data to an external apparatus can be performed.

One or more of the functions performed by the processor 10 may be implemented by hardware that executes information processing not based on a program such as a logic circuit or the like. One or more of the above-described functions can also be performed by software and hardware such as a logic circuit.

In this disclosure, the digital signage program PRA is recorded in advance in the digital signage device 1, but the embodiments are not limited thereto. For example, the digital signage program PRA or a program having a similar function may be downloaded from an external device via the communication network 2 or may be installed from a non-transitory computer readable recording medium. As the recording medium, any form may be adopted as long as the recording medium can store a program such as an optical disk and can be read by the digital signage device 1. In addition, the functions installed in this manner may be partially performed by an OS or the like.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A digital signage device for outputting a guidance message in response to an inquiry from a user, comprising:
a display including a touch panel and configured to display a guidance screen;
an input device through which the user can make speech inputs;
an output device through which a guidance message is output; and
a processor configured to:
when the guidance screen is operated and the speech is input, convert speech data generated by the input device from the speech input into text data,
search the text data for one or more particular words and determine a politeness level based on the particular words found in the text data,
determine a plurality of response messages based on the text data,
select one of the response messages corresponding to the determined politeness level, and
control the output device to output the selected response message as a guidance message.

2. The digital signage device according to claim 1, further comprising:
a memory that stores a first table in which each of the particular words is associated with a score, wherein
the processor is further configured to calculate a sum of scores of the particular words included in the text data, and determine the politeness level using the sum of the scores.

3. The digital signage device according to claim 2, wherein
the memory further stores:
a second table in which speech contents are associated with response actions and
a third table in which each of the response actions is associated with a plurality of response messages corresponding to a plurality of politeness levels, and the processor is further configured to:
determine a speech content based on the text data,
search the second table for one of the response actions associated with the determined speech content, and
search the third table for one of the response messages associated with said one of the response actions and the determined politeness level.

4. The digital signage device according to claim 1, further comprising:
a network interface configured to communicate with a server, wherein
the processor is further configured to control the display to repeatedly display an advertisement received from the server until the guidance screen is operated.

5. The digital signage device according to claim 1, wherein the processor is further configured to, when the guidance screen is operated, control the display to display a reception screen showing a message that prompts the user to speak.

6. The digital signage device according to claim 1, wherein the processor is further configured to control the display to display the selected response message.

7. The digital signage device according to claim 1, further comprising:
a printer, wherein
the processor is further configured to control the printer to print an image showing the selected response message.

8. The digital signage device according to claim 1, further comprising:
a housing in which the processor is housed and having a front surface facing the user and along which the input device, the display, and the output device are arranged.

9. The digital signage device according to claim 8, wherein the output device includes a plurality of speakers between which the display is disposed.

10. The digital signage device according to claim 1, wherein
the digital signage device is a self-service point-of-sale (POS) terminal installed in a store, and
the preset response messages includes one of: a message indicating a location of a particular merchandise item displayed and sold in the store, and a message that indicates a stock quantity of a particular merchandise item.

11. A method for outputting a guidance message in response to an inquiry from a user, the method comprising:
displaying a guidance screen on a display including a touch panel;
receiving speech inputs from the user via an input device;
after the guidance screen is operated and the speech is input, converting speech data generated by the input device from the speech input into text data;
searching the text data for one or more particular words and determining a politeness level based on the particular words found in the text data;
determining a plurality of response messages based on the text data;
selecting one of the response messages corresponding to the determined politeness level; and
outputting the selected response message as a guidance message via an output device.

12. The method according to claim 11, further comprising:
storing in a memory a first table in which each of the particular words is associated with a score; and
calculating a sum of scores of the particular words included in the text data, wherein
the politeness level is determined using the sum of the scores.

13. The method according to claim 12, further comprising:
storing in the memory:
a second table in which speech contents are associated with response actions and
a third table in which each of the response actions is associated with a plurality of response messages corresponding to a plurality of politeness levels;
determining a speech content based on the text data;
searching the second table for one of the response actions associated with the determined speech content; and
searching the third table for one of the response messages associated with said one of the response actions and the determined politeness level.

14. The method according to claim 11, further comprising:
repeatedly displaying on the display an advertisement received from a server until the guidance screen is operated.

15. The method according to claim 11, further comprising:
after the guidance screen is operated, displaying a reception screen showing a message that prompts the user to speak.

16. The method according to claim 11, further comprising:
displaying the selected response message on the display.

17. The method according to claim 11, further comprising:
printing, from a printer, an image showing the selected response message.

18. The method according to claim 11, wherein the input device, the display, and the output device are arranged along a front surface of a housing.

19. The method according to claim 18, wherein the output device includes a plurality of speakers between which the display is disposed.

20. A non-transitory computer readable medium storing a program for outputting a guidance message in response to an inquiry from a user, wherein the program executed on a computer causes the computer to execute a method comprising:
displaying a guidance screen on a display including a touch panel;
receiving speech inputs from the user via an input device;
after the guidance screen is operated and the speech is input, converting speech data generated by the input device from the speech input into text data;
searching the text data for one or more particular words and determining a politeness level based on the particular words found in the text data;
determining a plurality of response messages based on the text data;
selecting one of the response messages corresponding to the determined politeness level; and
outputting the selected response message as a guidance message via an output device.
